(19) United States
(12) Patent Application Publication
(10) Pub. No.: US 2019/0212231 A1
(43) Pub. Date: Jul. 11, 2019

(54) SYSTEMS AND METHODS FOR SOLID PHASE EXTRACTION FOR CHROMOTOGRAPHIC ANALYSIS

(71) Applicant: PromoChrom Technologies Ltd., Surrey (CA)

(72) Inventor: Haibin Wan, Surrey (CA)

(21) Appl. No.: 15/866,324

(22) Filed: Jan. 9, 2018

(51) Int. Cl. G01N 1/20; G01N 1/40

(52) U.S. Cl. CPC G01N 1/2035; G01N 2001/205; G01N 1/405

(57) ABSTRACT

A two stage online solid phase extraction system including a first valve with a stator and a rotor. The stator includes a stator interface and a plurality of ports arranged into a plurality of port groups. The rotor includes a rotor interface abutting the stator interface, a first channel extending from an axial center of the rotor to at least a point on the rotor interface alignable with the common ports for fluid communication therewith; and a plurality of second channels, each second channel extending from at least a point on the rotor interface alignable with the common ports for fluid communication therewith to at least a point on the rotor interface alignable with the first non-common ports and/or the second non-common ports for fluid communication therewith.

### TECHNICAL FIELD

The present invention relates to automated sample preparation apparatus for chemical analysis and, more particularly, relates to systems and methods for solid phase extraction for chromatographic analysis.

### BACKGROUND

Sample handling apparatus based on solid phase extraction (SPE) are used for cleanup and enrichment of samples prior to chromatographic analysis. Typical operating procedures of such apparatus includes: 1) eluting a SPE column packed with a sorbent using a solvent to wet the sorbent bed, 2) loading a sample fluid to the column, 3) eluting the column again with a solvent to remove the interfering components from the sample matrices, and 4) washing down the target components in the sample from the column using a solvent and collecting the target components fraction for further chromatographic analysis. The collected fractions may be transferred to a liquid chromatograph (LC) for final analysis manually as in the case of a standalone SPE apparatus or automatically as in the case of a online SPE apparatus.

An online SPE apparatus can transfer the collected fraction to a LC automatically. It can reduce the workload of laboratory staff and also improve the reliability of the analytical results by reducing human errors. Currently available online SPE apparatus may use either one of the two approaches for integration with liquid chromatographic analysis: direct coupling and indirect coupling. FIG. 1a shows an instrument configuration for direct coupling using a high pressure switching valve 500. The valve has ports 501 to 506 on the surface and a rotor beneath with flow channels 601 to 603. Sample SA is loaded to a SPE column C2 using pump SP. SPE column C2 is then washed using solvent S2 to remove interfering materials from the sample matrices. When the rotor rotates an angle of 60 degrees clockwise, the connection pattern of the valve changes from sample loading mode to injection mode as indicated in FIG. 1b. SPE column C2 is in fluid communication with LC pump LP. The elution solvent S1 from LC pump LP will transfer the targeted components trapped on SPE column C2 to the LC analytical column C3 for separation and then to LC detector LD for detection and quantitation.

Using the direct approach can achieve high sensitivity since the whole portion of sample loaded to SPE column C2 is used for final LC quantitation. A disadvantage with the direct approach is limited selection of suitable SPE columns. This is because the SPE column needs to have properties similar to the LC column to avoid adverse effects on the chromatographic separation. Also, the SPE column needs to have good lifetime, since it is not easy to change a SPE column that is fixed to a high pressure switching valve and such SPE columns are much more expensive than those used in standalone SPEs. Because of these limits, the direct approach is normally used for samples of simple matrices, such as drinking water.

Some online SPE apparatus based on direct integration approach may use more than one SPE column and switching valve for different sample preparation needs. Examples are presented in U.S. Pat. No. 7,588,725 B2 (Can Ozbal, Donald Green), U.S. application Ser. No. 15/129,543 (Sang-won Lee, Hang yeore LEE), and U.S. Pat. No. 5,468,643A (Syang Y. Su, Gerald K. Shiu). Their common feature is that the SPE columns are fixed on the switching valves and thus have the same limits indicated above for direct integration approach.

In case of the indirect approach, the online SPE apparatus is the same as a standalone SPE apparatus plus a switching valve for injecting the collected fraction to a LC. As demonstrated in FIG. 1c, sample SA is first treated like in the case of a standalone SPE. The purified fraction F is collected from SPE column C1 and an aliquot (normally not more than 20 micro liters) of collected fraction containing targeted components is loaded to the loop on switching valve 500 using pump SP. When valve 500 is switched to injection mode, the loop is in fluid communication with the LC pump LP. Solvent S1 from the LC pump will transfer the sample fraction from the loop to the LC column for separation and then to LC detector LD for quantitation.

The indirect integration approach can overcome the limits with the direct approach in finding suitable SPE columns. This is because each SPE column is only used for one sample such that the lifetime of the SPE column and the matrices of the sample are not an issue. Also, since only a very small portion of collected fraction from the SPE column is transferred to the LC column, the properties of the SPE column have much less effect on LC separation. Therefore, users have more choices of suitable SPE columns for cleanup and enrichment of their samples. However, the indirect approach does have the disadvantage of lower sensitivity than the direct approach as only a very small portion of a sample is used for quantitation by LC.

Rotary valves are used in sample handling apparatus to divert solvents and sample fluids (e.g., multi-position valves manufactured by VICI Co., Houston, Tex., USA). These rotary valves normally have one inlet port (typically placed in the rotary axis of the valve) and a number of outlet ports that are placed around the inlet port. The rotor inside the valve has a single, radially extending groove that has one end in the rotary centre, thereby connecting the inlet with any one of the outlet ports.

In some applications of sample handling, the flow direction through a SPE column or other components needs to be reversed to accelerate regeneration of the column or to minimize peak broadening of the targeted components during valve switching. The above described common type rotary valves cannot fulfil this task without using additional means, such as a flow redirecting valve or a second pump.

A prior art rotary valve that can reverse the flow direction without using additional means was described in U.S. Pat. No. 8,186,381 B2 (Anders Wilen). This rotary valve can divert fluid to any of the components connected to the valve and can also reverse the flow through a component by rotating the rotor to a certain angle. However, as shown in FIG. 2, all the components connected to the ports of this valve share the same outlet. This design is convenient when the content from all the components is to be transferred to the same destination. In some cases of sample preparation practice, such as those for which the present invention are directed, the content from each component needs to have more than one destination.

Another prior art rotary valve that can reverse the flow direction without using additional means was described in U.S. Pat. No. 8,813,785 B2 (Haibin Wan). The connection ports on this valve are arranged into groups. Each group has at least three ports with one acting as a common port and the others acting as non-common ports. Each port group can be used to connect one SPE column, using the common port as the fluid outlet. This rotary valve can reverse the flow through the SPE columns connected to it by rotating the rotor to a certain angle. As shown in FIGS. 3a and 3b, all four SPE columns connected to the four groups of ports on this valve always have an identical connection pattern. This design can considerably simplify the hardware and control software for apparatus that process multiple samples in parallel mode. This valve is not suitable, however, when an application needs to use some port groups for different purpose or not to access all the port groups in parallel mode.

The object of the present invention is to provide systems and methods for online SPE for LC analysis that can overcome the disadvantages and maintain the advantages of the known online SPE apparatus.

### SUMMARY OF THE INVENTION

Aspects of the invention include systems and methods that use a multifunctional rotary valve that can divert fluid through the SPE columns in forward and reversed directions.

In some aspects, the system comprises a pump, a multifunctional rotary valve, a 6-port switching valve, and a three way valve. Other components are trays for carrying and moving samples, SPE columns, and the fraction containers, as well as linear actuators for moving the needles and adapters for connecting the SPE columns. With the present 2-stage online SPE apparatus, a sample is first processed using a SPE column as in a standalone SPE. The collected fraction is then loaded onto the second SPE column fixed on a switching valve and directly coupled with a LC instrument. The targeted components from the sample fraction is enriched and further cleaned on the second SPE column before being transferred to LC for final analysis.

The first SPE column is used to remove most interfering materials from the sample matrices. Since it uses conventional columns for standalone SPE, it is much easier to find suitable SPE columns and achieve good cleanup results. The fraction loaded to the second SPE column contains much less interfering materials and thus the lifetime of the second SPE column is extended considerably. Besides, a much larger volume of the collected fraction from the first SPE column is used for LC quantitation thanks to the enrichment effect of the second SPE column and thus achieve good sensitivity.

The core component of the online SPE apparatus is a multi functional rotary valve that can connect the syringe pump with sample, elution solvents, SPE columns, and collected fractions, and can also elute the two SPE columns in two directions. The multi functional valve comprises a stator and a rotor. The stator comprises: a stator interface and a plurality of ports. One of the ports is located in the rotary axis of the valve and designated as central port. The other ports are arranged into a plurality of port groups surrounding the central ports. Each port group comprises at least three ports of which one is designated as a common port and the others are designated as non-common ports. The non-common ports comprise a first non-common port and a second non-common port. Each of the common ports, first non-common ports and the second non-common ports are circularly arranged at the stator interface.

The rotor comprises a rotor interface abutting said stator interface. The rotor also comprises a first channel extending from an axial center of the rotor to at least a point on the rotor interface alignable with the surrounding ports. The rotor also comprises at least two second channels, each second channel extending from at least a point on the rotor interface alignable with a surrounding port to at least a point on the rotor interface alignable with a neighboured surrounding port.

The rotor is coaxially rotatable relative to the stator to configure the fluid selection valve in at least three different connection status; wherein in a first status, the common port of a port group is in fluid communication with the central port via the first channel; wherein in a second status, the common port of a port group is in fluid communication with the first non-common port in the same group via a second channel and the second non-common port is in fluid communication with the central port; and wherein in a third status, the common port of a port group is in fluid communication with the second non-common port in the same group via another second channel and the first non-common port is in fluid communication with the central port.

In one aspect the central port of the fluid selection valve may located in the axial center of the stator. The first channel and the second channels may extend in a plane generally orthogonal to the axis of the rotor. The rotor and the stator may each comprise a substantially disc-shaped body. The first channel and the second channels may comprise generally linear grooves on a surface of the rotor interface, or bores within the rotor below a surface of the rotor interface.

The circular arrangements of the common ports, first non-common ports and the second non-common ports at the stator interface may overlap. The plurality of ports may comprise four port groups, and each port group may comprise three ports of which one is designated as the common port and the other two are designated as the non-common ports, and wherein the rotor comprises one first channel and two second channels, wherein the length of each first channel is equal to a distance of a non-common port to the central port, and wherein the length of each second channel is equal to a distance of the common port to the non-common ports within the same port group.

The common ports may be located on a first imaginary circle, the non-common ports may be located on a second imaginary circle, and the first circle may be concentric but non-overlapping with the second circle.

### BRIEF DESCRIPTION OF DRAWINGS

In drawings which show non-limiting embodiments of the invention:

FIG. 1a is a schematic view for an online SPE system directly integrated with a liquid chromatograph (sample loading mode).

FIG. 1b is a schematic view for an online SPE system directly integrated with a liquid chromatograph (injection mode).

FIG. 1c is a schematic view for an online SPE system indirectly integrated with a liquid chromatograph.

FIG. 2 is a schematic view of a prior art rotary valve with capability of flow reverse.

FIG. 3a is a schematic view of another prior art rotary valve with capability of flow reverse.

FIG. 3b is a schematic view of another prior art rotary valve with capability of flow reverse after switching.

FIG. 4 is a side section view of a fluid selection valve according to an example embodiment of the present invention.

FIG. 5 is an exploded isometric view of the fluid selection valve of FIG. 4.

FIG. 6 is an exploded view of the stator and the rotor of a fluid selection valve according to an example embodiment of the present invention.

FIG. 7 is a top view of the fluid selection valve of FIG. 6 showing a port connection pattern.

FIG. 8 is a top view of the fluid selection valve of FIG. 6 showing another port connection pattern.

FIG. 9 is an isometric view of a rotor of a fluid selection valve according to an example embodiment of the present invention.

FIG. 10 is a schematic view of an online SPE system according to an embodiment of the invention.

FIG. 11a is a schematic view of the system of FIG. 10 in solvent drawing status.

FIG. 11b is a schematic view of the system of FIG. 10 in status of drawing sample SA.

FIG. 11c is a schematic view of the system of FIG. 10 in status of loading sample SA or elution solvents S1-S3 to SPE column C1 in a normal direction.

FIG. 11d is a schematic view of the system of FIG. 10 in status of loading sample SA or elution solvents S1-S3 to SPE column C1 in a reversed direction.

FIG. 11e is a schematic view of the system of FIG. 10 in status of connecting syringe pump SP with the collected fraction F via three-way valve 700 and adapter P3.

FIG. 11f is a schematic view of the system of FIG. 10 in status of loading sample SA, collected fraction F or elution solvents S1-S3 to SPE column C2 in a normal direction.

FIG. 11g is a schematic view of the system of FIG. 10 in status of loading sample SA, collected fraction F or elution solvents S1-S3 to SPE column C2 in a reversed direction.

FIG. 11h is a schematic view of the system of FIG. 10 in status of connecting SPE column C2 with LC column C3 for injection via switching valve 500.

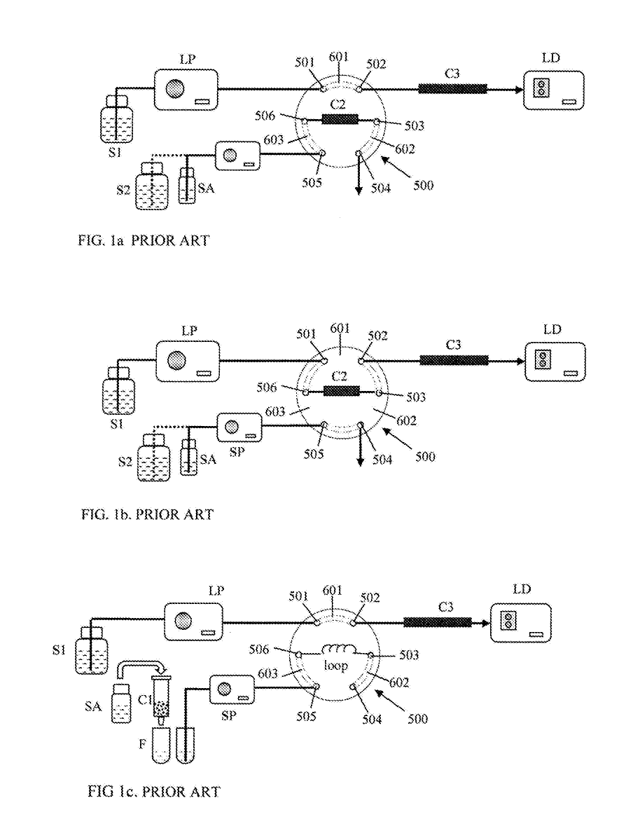

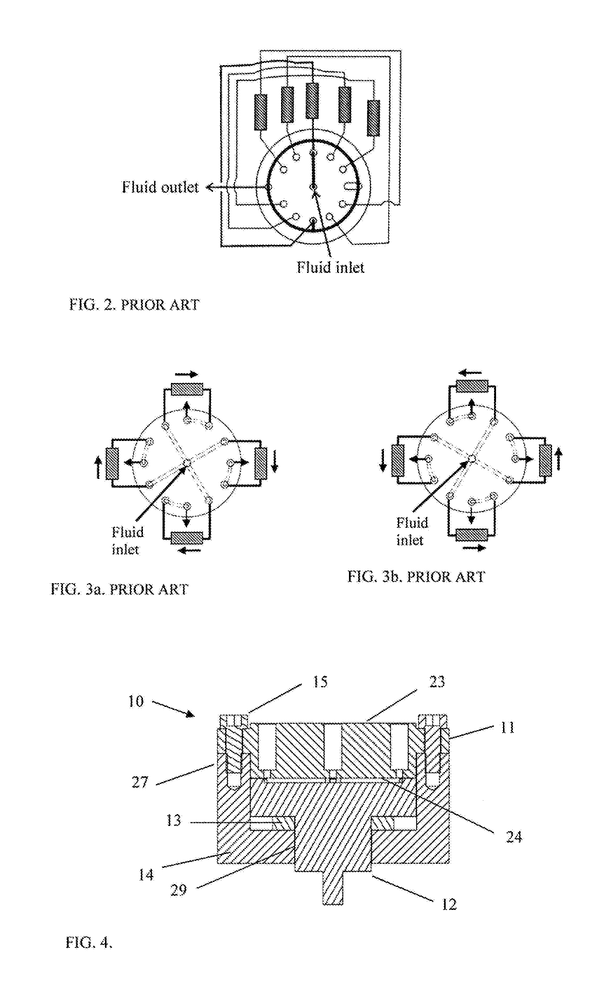

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

According to aspects of the invention, the two-stage online SPE apparatus comprises a syringe pump, a multifunctional rotary valve, a 6-port switching valve, and a three-way valve. The multi functional rotary valve comprises a stator having a plurality of ports for connecting fluid lines thereto, and a rotor coaxially rotatable with respect to the stator. The rotor comprises channels. The ports on the stator are arranged in a plurality of groups. The stator has at least one group of ports. Each group has at least three ports, among which one of the ports is used as common port. The common port may be used as an outlet or inlet for fluid flowing through a component connected to the two non-common ports in the same group, for example. The stator also comprises a central port. The central port may be used to connect with a pump to deliver solvents to other ports on the stator or may be used as a common outlet for other ports on the stator. The channels on the rotor are arranged such that by rotating the rotor the common port in each group of the ports of the stator can be connected with one of the other two ports in the group or to the port located in the center of the stator and that when the central port is connected to one non-common port, the other non-common port in the same group is always connected to the common port in that group.

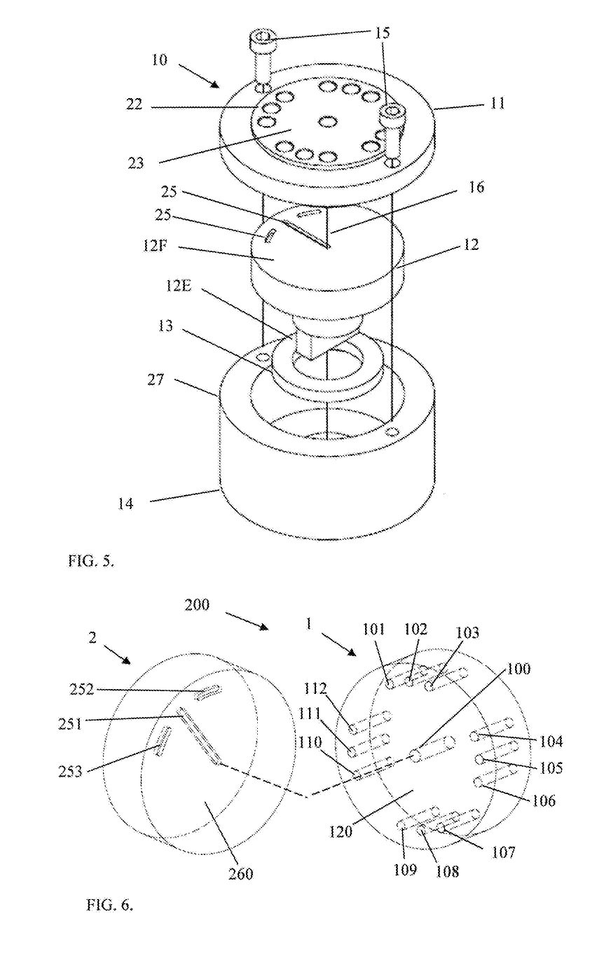

FIGS. 4 and 5 illustrate a rotary valve 10 constructed in accordance with a first example embodiment of the present invention. Valve 10 comprises a stator 11 and a rotor 12. Stator 11 has an upper face 23 and an interface 24. Stator 11 includes a plurality of ports 22 that vertically extend through the body of stator 11. Ports 22 are configured to receive fluid lines. Rotor 12 has an interface 12F and an extension 12E for engaging a drive motor (not shown). Rotor 12 includes a plurality of channels 25 for fluid communication with ports 22, as described in further detail below.

Stator 11 and rotor 12 are received in a housing 14. Stator 11 is rigidly fixed to upper annular sidewalls 27 of housing 14 by a plurality of fasteners 15. Fasteners 15 may for example be screws which are received in corresponding threaded holes 28 in upper annular sidewalls 27. In other embodiments, stator 11 may be fixed to housing 14 in any other manner known in the art.

Rotor 12 is held within housing 14 by stator 11. Rotor extension 12E extends through an opening 29 at the bottom of housing 14. Rotor 12 is coaxially rotatable relative to stator 11 about axis 16 of stator 11. Some embodiments may include a washer 17 to facilitate a sealed connection and relative rotation between rotor upper face 12F and stator lower face 4. Some embodiments may also include a washer 13 to facilitate a sealed connection and relative rotation between rotor 12 and housing 14.

FIGS. 6 to 8 show rotary valve 200 according to an example embodiment. Valve 200 is similar to valve 10 but some elements such as the stator ports have different dimensions. FIGS. 6 to 8 show a simplified view of selection valve 200, e.g. selection valve 200 is shown without its equivalents of housing 14 and rotor extension 12E. Valve 200 comprises a stator 1 and a rotor 2, both of which are substantially disc-shaped. Central port 100 extends through a center axis of stator 1. A plurality of additional ports is concentrically arranged around central port 100 along an imaginary circle 261. The illustrated embodiment has twelve additional ports. These twelve ports are divided into four groups, each group consisting of three ports. Ports 101 to 103 define group 1, ports 104 to 106 define group 2, ports 107 to 109 define group 3, and ports 110 to 112 define group 4. Each group has a common port, namely ports 102, 105, 108, and 111 respectively. In other embodiments, the stator may have one, two, three, or more than four groups of ports. In other embodiments, each port group may consist of more than three ports.

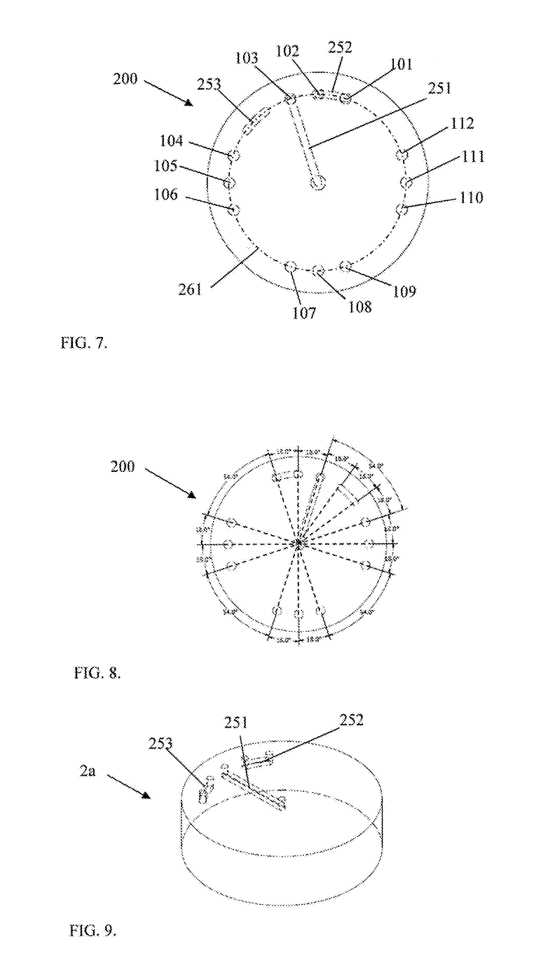

Channels on rotor 2 are formed with two types on interface 260 of rotor 2. The first channel radiates from the axial center of rotor 2 or center of interface 260. In the illustrate embodiment, the first channel is linear groove 251. As shown in FIG. 7, groove 251 substantially corresponds in length and location to radii of imaginary circle 261. The first channel extend from an axial center of the rotor to at least a point alignable with one or more of the ports to provide fluid communication between central port 100 and one or more of the surrounding ports (i.e., ports 101-112), or at least between central port 100 and common ports 102, 105, 108, and 111.

Two second channels are arranged with the first channel in between and in a concentric manner around the center of interface 260 of rotor 2 along a path corresponding to imaginary circle 261 when rotor 2 and stator 1 are fitted together (see FIG. 7). In the illustrated embodiment, the two second channels are linear grooves 252 and 253. The second channels extend from a point alignable with the common ports to a point alignable with their adjacent ports in each group to provide fluid communication between the common ports and their adjacent ports. Both first channel and second channels of rotor 2 extend in a plane generally orthogonal to the central axis of rotor 2.

In FIG. 7, non-common port 103 is in fluid communication with central port 100 via groove 251 and non-common port 101 is in fluid communication with common port 102 via grove 252.

FIG. 8 is a top view of the embodiment shown in FIG. 6 after rotor 2 is rotated an angle clockwise. As shown in FIG. 8, non-common port 101 is in fluid communication with central port 100 via grove 251 and non-common port 103 is in fluid communication with common port 102 via grove 253. If rotor 2 rotates a further angle counter clockwise, common port 102 will be in fluid communication with central port 100 via grove 251.

Accordingly, by selectively rotating rotor 2 coaxially with respect to stator 1, each port can have one of four statuses: 1) in fluid communication with a first one of their adjacent ports in the same group; 2) in fluid communication with a second one of their adjacent ports in the same group; 3) in fluid communication with central port 100, or 4) blocked from all the other ports.

FIG. 9 is an isometric simplified view of a rotor 2a according to another example embodiment. The only difference between rotor 2a and rotor 2 is that channels 251-253 comprise bores disposed below the surface of the rotor interface in the second embodiment. The design of rotor 2a is useful to reduce cross-contamination of samples on the rear surface of the stator.

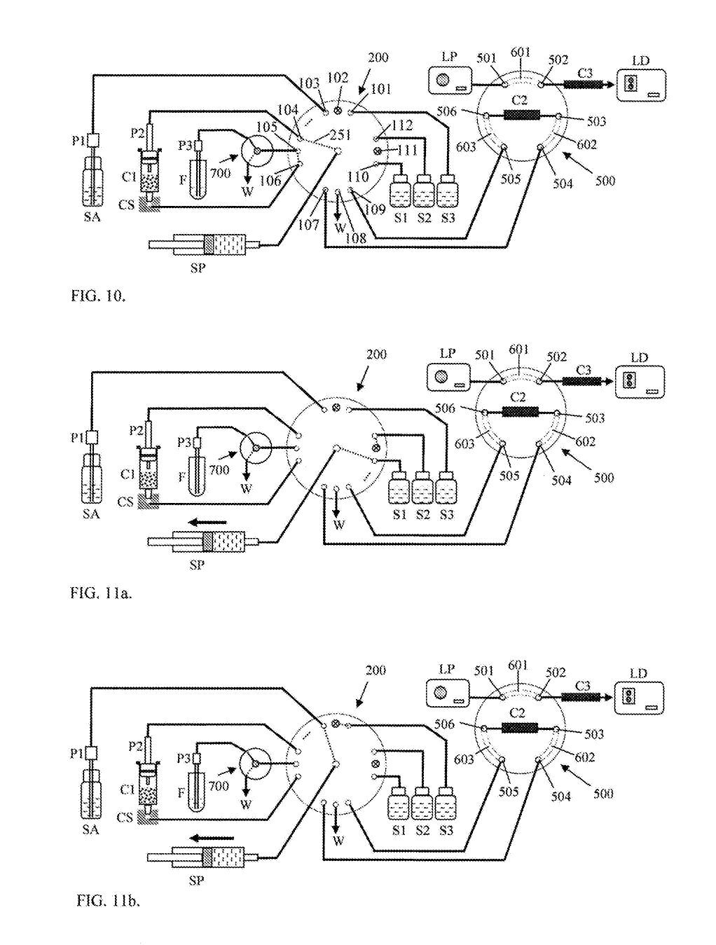

FIG. 10 is a schematic view of the present invention of a two-stage online SPE apparatus. The apparatus comprises a rotary valve 200, a three-way valve 700, a switching valve 500, and a syringe pump SP. One group of ports (104-106) on valve 200 is used to connect SPE column C1, with the two non-common ports connected to the two ends of SPE column C1 via adapters P2 and CS and the common port used as outlet for effluent from SPE column C1. Another group of ports (107-109) on valve 200 is used to connect SPE column C2 that is fixed on valve 500, with the two non-common ports connected to the two ends of SPE column C2 via ports 504 and 505 on valve 500 and the common port used as outlet for effluent from SPE column C2. By rotating valve 200, fluid from syringe pump SP can flow through SPE columns C1 and C2 in normal or reversed direction. The other two groups of ports on valve 200 are used to connect with solvents S1-S3 and sample SA. Ports not used on valve 200 are blocked (102 and 111). When more types of solvent are needed for some applications, the number of open ports on valve 200 can be increased. Valve 500 is a two position and 6 port switching valve and used to connect SPE column C2 with LC pump LP and LC column C3 for LC analysis. Valve 700 is a three-way switching valve and used to divert fluid from port 105 of valve 200 either to waste W or to the fraction F via adapter P3. Valves 500 and 700 are commonly available and widely used in liquid handling apparatus. As a fully automated online SPE apparatus for handling multiple samples, linear actuators are used to move adapters P1-P3 and CS up and down and carrier trays are used to transfer multiple SPE columns, containers for samples and collected fraction. These components are not shown here.

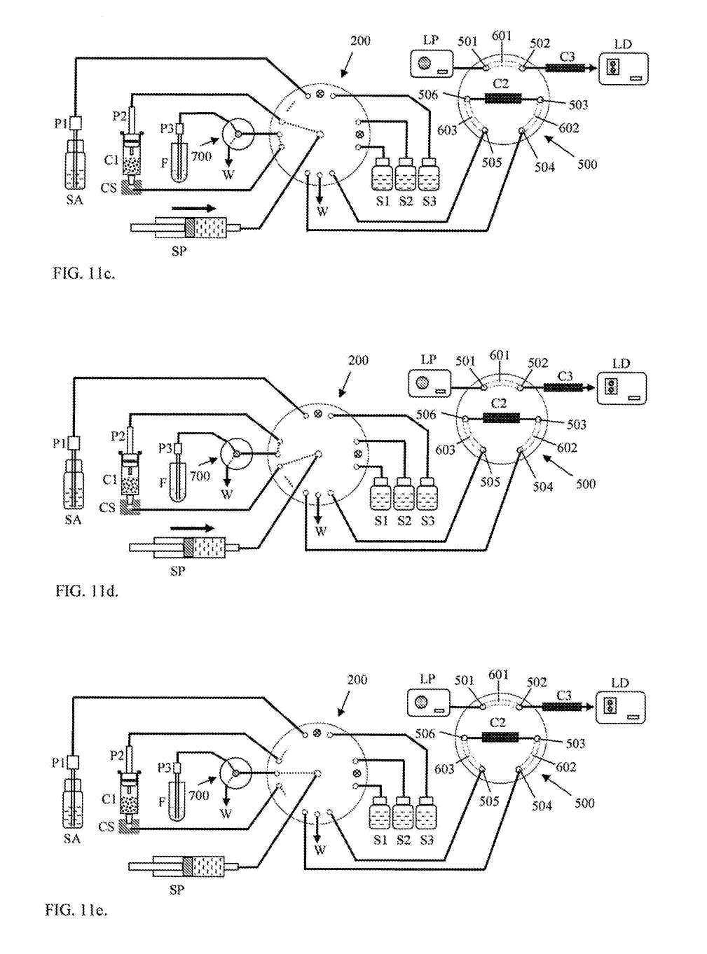

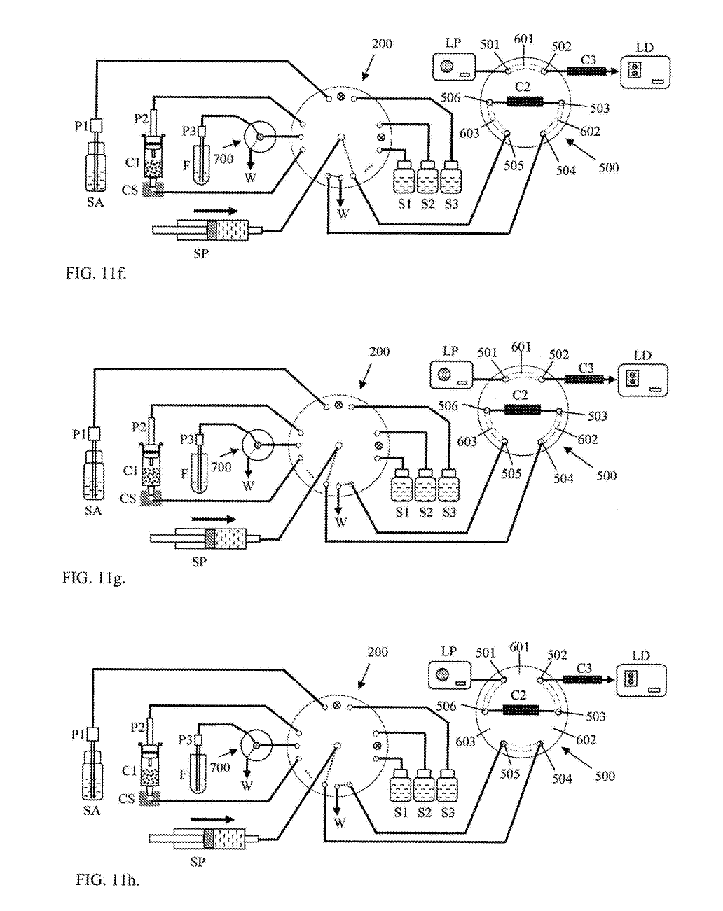

FIGS. 11a to 11h show eight connection patterns for fluid transfer of the two-stage online SPE apparatus represented by FIG. 10. These connection patterns are used for sample preparation using two-stage online SPE and are realized by switching valves 200, 500, and 700.

Herewith a typical sample preparation procedure for two-stage online SPE is used as an example to explain the working principle of the present apparatus.

The first step is eluting SPE column C1 with solvent S1 to wet the sorbent bed. The working steps are 1) rotating valve 200 to connect syringe pump SP with solvent S1 and drawing solvent into the syringe pump SP (FIG. 11a); 2) rotating valve 200 again to connect syringe pump with SPE column C1 via adapter P2 and pushing the solvent from syringe pump to SPE column C1 in normal direction (FIG. 11c). Effluent from SPE column C1 flows to waste via valve 700.

The second step is loading sample SA to SPE column C1 in reversed direction. The working steps are 1) rotating valve 200 to connect syringe pump SP with sample SA via adapter P1 and drawing sample fluid into the syringe pump (FIG. 11b); 2) rotating valve 200 again to connect syringe pump SP with SPE column C1 via adapter CS and pushing the sample fluid to SPE column C1 in a reversed direction (FIG. 11d). Effluent from SPE column C1 flows to waste via valve 700. In this step, sample fluid can also be added to SPE column in a normal direction by rotating valve 500 to another position (FIG. 11c). Adding sample to SPE column C1 in a reversed direction can make the following steps faster for removing interfering components and collecting the fraction of targeted components.

The third step is washing away interfering components from sample matrices from SPE column C1 using solvent S2. The working steps are 1) rotating valve 200 to connect syringe pump with solvent S2 and drawing solvent to the syringe pump; 2) rotating valve 200 to connect syringe pump SP with SPE column 01 via adapter P2 and pushing solvent S2 to SPE column C1 in a normal direction (FIG. 11c). Effluent from SPE column C1 flows to waste via valve 700.

The fourth step is washing down the targeted components from SPE column C1 using solvent S3 and collecting the fraction F. The working steps are 1) rotating valve 200 to connect syringe pump SP with solvent S3 and drawing solvent into the syringe pump; 2) rotating valve 200 to connect syringe pump SP with SPE column C1 via adapter P2, switching valve 700 to connect adapter P3 with the effluent of SPE column C1 via adapter CS and pushing solvent S3 to SPE column C1 in a normal direction (FIG. 11c). The apparatus may be used as a standalone SPE system as well. In such case the collected fraction can be manually transferred to other apparatus, such as a gas chromatograph or an evaporator, for analysis or further treatment.

The fifth step is transferring the collected fraction to SPE column C2 for further cleanup and enrichment. The working steps are: 1) rotating valve 200 and valve 700 to connect syringe pump SP with collected fraction F via adapter P3 and drawing fraction fluid into syringe pump (FIG. 11e); 2) rotating valve 200 and valve 500 to connect syringe pump SP with SPE column C2 and loading the fraction fluid to SPE column C2 in reversed direction. Effluent from SPE column C2 flows to waste W (FIG. 11g). In this step, collected fraction F may, in the alternative, be added to SPE column C2 in a normal direction by rotating valve 500 to another position (FIG. 11f). Adding the sample to SPE column C2 in a reversed direction can make it easier for removing interfering components and avoid peak broadening when transferring the targeted components from SPE column C2 to LC column C3. Peak broadening during the transfer step can have adverse effects on LC analysis.

The sixth step is washing the SPE column C2 to remove more interfering components using solvent S2. The working steps are: 1) rotating valve 200 to connect syringe pump SP with solvent S2 and drawing solvent S2 into syringe pump SP; 2) rotating valve 200 again to connect syringe pump SP with SPE column C2 and pushing the solvent to SPE column C2 in a normal direction (FIG. 11f).

The seventh step is transferring targeted components from SPE column C2 to LC column C3 for LC analysis. The working step is rotating valve 500 to connect SPE column C2 with LC pump LP and LC column C3 (FIG. 11h). Fluid from LP pump will bring the targeted components trapped on SPE column C2 to LC column C3 for separation and then to LC detector LD for quantitation.

While a number of exemplary aspects and embodiments of the invention have been discussed above, those of skill in the art will recognize certain modifications, permutations, additions and sub-combinations thereof. The scope of the claims should not be limited by the preferred embodiments set forth in the examples, but should be given the broadest interpretation consistent with the description as a whole.

1. A two stage online solid phase extraction system comprising:
a first valve comprising:
a stator comprising
a stator interface;
a plurality of ports arranged into a plurality of port groups,
wherein each port group comprises at least three ports of which one is designated as a common port and the others are designated as non-common ports, the non-common ports comprising a first non-common port and a second non-common port, wherein each of the common ports, first non-common ports and the second non-common ports are circularly arranged at the stator interface;
a rotor comprising:
a rotor interface abutting said stator interface;
a first channel extending from an axial center of the rotor to at least a point on the rotor interface alignable with the common ports for fluid communication therewith;
a plurality of second channels, each second channel extending from at least a point on the rotor interface alignable with the common ports for fluid communication therewith to at least a point on the rotor interface alignable with the first non-common ports and/or the second non-common ports for fluid communication therewith;
wherein at least one of the stator and the rotor comprises a central port located in an axial center thereof;
a first pump in fluid communication with the central port of the first valve;
a sample source in fluid communication with the first valve;
a plurality of solvent sources in fluid communication with the first valve;
a first solid phase extraction column in fluid communication with the first valve;
a second valve comprising three ports, wherein any two of the three ports are in fluid communication depending on a switching configuration of the second valve, wherein the second valve is in fluid communication with the first valve; and
a fraction collector in fluid communication with the second valve.

2. A system according to claim 1 further comprising:
a switching valve in fluid communication with the first valve;
a second pump in fluid communication with the switching valve;
a second solid phase extraction column in fluid communication with the switching valve; and
a liquid chromatography column in fluid communication with the switching valve.

3. A system according to claim 2, wherein the first channel and second channels of the first valve comprise generally linear grooves on a surface of the rotor interface.

4. A system according to claim 2, wherein the first channel and second channels of the first valve comprise bores within the rotor below a surface of the rotor interface.

5. A system according to claim 2, wherein the rotor of the first valve consists of the first channel and two of the second channels.

6. A system according to claim 5, wherein the first channel comprises a linear groove, and the second channels are arranged equidistantly apart on and extend away from each side of the first channel.

7. A system according to claim 6, wherein the first solid phase extraction column is in fluid communication with a first non-common port and a second non-common port of a first group of ports of the first valve, and wherein a first port of the second valve is in fluid communication with a common port of the first group of ports of the first valve.

8. A system according to claim 7, wherein the switching valve comprises:
a stator comprising at least three groups of at least two ports; and
a rotor comprising a plurality of channels, each channel alignable with the stator to provide fluid communication between the ports of each of the groups.

9. A system according to claim 8 wherein a first non-common port of a second group of ports of the first valve is in fluid communication with a first port of a second group of ports of the switching valve, and wherein a second non-common port of the second group of ports of the first valve is in fluid communication with a second port of a first group of ports of the switching valve.

10. A system according to claim 9, wherein the second pump is in fluid communication with a first port of a third group of the switching valve.

11. A system according to claim 10, wherein the second solid phase extraction column is in fluid communication with a first port of the first group of ports of the switching valve and with a second port of the second group of ports of the switching valve.

12. A system according to claim 11, wherein the liquid chromatography column is in fluid communication with a first port of the third group of ports of the switching valve.

13. A system according to claim 12, comprising a liquid chromatography detector in fluid communication with the liquid chromatography column.

14. A system according to claim 13 comprising:
a first solvent source in fluid communication with a first non-common port of a third group of ports of the first valve;
a second solvent source in fluid communication with a second non-common port of the third group of ports of the first valve; and
a third solvent source in fluid communication with a first non-common port of a fourth group of ports of the first valve.

15. A system according to claim 14 wherein the sample source is in fluid communication with a second non-common port of the fourth group of ports of the first valve.

16. A system according to claim 15 wherein: the common port of the second group of ports is in fluid communication with a second waste outlet; the common ports of the third and fourth group of ports of the first valve are closed; the second port of the second valve is in fluid communication with the fraction collector; and the third port of the second valve is in fluid communication with a first waste outlet.

17. A method of solid phase extraction for chromatographic analysis, the method comprising:
a. providing a system according to claim 16;
b. wetting the first solid phase extraction column by:
i. rotating the first valve so that the first channel is in fluid communication with the first non-common port of the third group of ports of the first valve and drawing a first solvent from the first solvent source into the first pump;
ii. rotating the first valve so that the first channel is in fluid communication with the first or second non-common port of the first group of ports of the first valve, and common port of the first group of ports is in fluid communication with the other of the first or second non-common port of the first group of ports via one of the second channels, and switching the second valve so that the common port of the first group of ports of the first valve is in fluid communication with the first waste outlet, and then flushing the first solid phase extraction column with the first solvent from the first pump to the first waste outlet;
c. loading a sample into the first solid phase extraction column by:
i. rotating the first valve so that the first channel is in fluid communication with the first non-common port of the fourth group of ports of the first valve, and drawing a sample from the sample source into the first pump;
ii. rotating the first valve so that the first channel is in fluid communication with the first or second non-common port of the first group of ports of the first valve, and the common port of the first group of ports is in fluid communication with the other of the first or second non-common port of the first group of ports via one of the second channels, and switching the second valve so that the common port of the first group of ports of the first valve is in fluid communication with the first waste outlet, and then pushing the sample into the first solid phase extraction column from the first pump to the first waste outlet;
d. washing the first solid phase extraction column by:
i. rotating the first valve so that the first channel is in fluid communication with the second non-common port of the third group of ports of the first valve, and drawing a second solvent from the second solvent source into the first pump;
ii. rotating the first valve so that the first channel is in fluid communication with the first or second non-common port of the first group of ports of the first valve, and the common port of the first group of ports is in fluid communication with the other of the first or second non-common port of the first group of ports via one of the second channels, and switching the second valve so that the common port of the first group of ports of the first valve is in fluid communication with the first waste outlet, and then flushing the first solid phase extraction column with the second solvent from the first pump to the first waste outlet;
e. recovering one or more target components from the first solid phase extraction column by:
i. rotating the first valve for the first channel to be in fluid communication with the first non-common port of the fourth group of ports of the first valve, and drawing a third solvent from the third solvent source into the first pump;
ii. rotating the first valve so that the first channel is in fluid communication with the first or second non-common port of the first group of ports of the first valve, and the common port of the first group of ports is in fluid communication with the other of the first or second non-common port of the first group of ports via one of the second channels, and switching the second valve so that the common port of the first group of ports of the first valve is in fluid communication with the fraction collector, and then flushing the first solid phase extraction column with the third solvent from the first pump so that the one or more target components are recovered by the fraction collector;
f. loading the one or more target components into the second solid phase extraction column by:
i. rotating the first valve so that the first channel is in fluid communication with the common port of the first group of ports of the first valve, and switching the second valve so that the common port of the first group of ports of the first valve is in fluid communication with the fraction collector;
ii. drawing the one or more target components from the fraction collector into the first pump;
iii. rotating the first valve so that the first channel is in fluid communication with the first or second non-common port of the second group of ports of the first valve, which in turn is in fluid communication with the second solid phase extraction column through the switching valve, and one of the second channels is in fluid communication with both the second solid phase extraction column through the switching valve and, through the other of the first and second non-common port of the second group of ports of the first valve, the second waste outlet, and then pushing the one or more target components into the second solid phase extraction column from the first pump to the second waste outlet;
g. washing the second solid phase extraction column by:
i. rotating the first valve so that the first channel is in fluid communication with the second non-common port of the third group of ports of the first valve, and drawing a second solvent from the second solvent source into the first pump;
ii. rotating the first valve so that the first channel is in fluid communication with the first or second non-common port of the second group of ports of the first valve, which in turn is in fluid communication with the second solid phase extraction column through the switching valve, and one of the second channels is in fluid communication with both the second solid phase extraction column through the switching valve and, through the other of the first and second non-common port of the second group of ports of the first valve, the second waste outlet, and then flushing the second solvent through the second solid phase extraction column from the first pump to the second waste outlet;
h. loading the one or more target components into the liquid chromatography column by:
i. rotating the switching valve so that the second pump and the liquid chromatography column are both in fluid communication with the second solid phase extraction column; and
ii. pushing the one or more target components into the liquid chromatography column from the second solid phase extraction column with fluid from the second pump.

18. The method according to claim 17 wherein one or more of steps b.ii., d.ii., and g.ii. comprise rotating the first valve so that the flushing is in the normal flow direction.

19. The method according to claim 18 wherein step c.ii. and/or step f.iii. comprises rotating the first valve so that the pushing is in the reverse flow direction.

20. A rotary valve comprising:
a stator comprising
a stator interface;
a plurality of ports arranged into a plurality of port groups, wherein each port group comprises at least three ports of which one is designated as a common port and the others are designated as non-common ports, the non-common ports comprising a first non-common port and a second non-common port, wherein each of the common ports, first non-common ports and the second non-common ports are circularly arranged at the stator interface;
a rotor consisting of:
a rotor interface;
a first channel consisting of a linear groove extending from an axial center of the rotor to at least a point on the rotor interface alignable with the common ports for fluid communication therewith; and
two second channels, each second channel extending from at least a point on the rotor interface alignable with the common ports for fluid communication therewith to at least a point on the rotor interface alignable with the first non-common ports and/or the second non-common ports for fluid communication therewith, the second channels arranged equidistantly apart on and extend away from each side of the first channel;
wherein at least one of the stator and the rotor comprises a central port located in an axial center thereof.
